(19) United States
(12) Patent Application Publication
(10) Pub. No.: US 2026/0072152 A1
(43) Pub. Date: Mar. 12, 2026

(54) SYSTEM FOR DETECTING PASSENGERS WHO HAVE NOT GOTTEN OFF SCHOOL BUS USING RADAR SENSORS

(71) Applicant: SMART RADAR SYSTEM, INC., Seongnam-si (KR)

(72) Inventors: Young Woo JEONG, Suwon-si (KR); Yong Jae KIM, Yongin-si (KR)

(73) Assignee: SMART RADAR SYSTEM, INC., Seongnam-si (KR)

(21) Appl. No.: 19/284,702

(22) Filed: Jul. 30, 2025

(30) Foreign Application Priority Data
Sep. 10, 2024 (KR) 10-2024-0123258

(51) Int. Cl. G01S 13/04; G01S 13/88

(52) U.S. Cl. CPC G01S 13/04; G01S 13/88

(57) ABSTRACT

A system for detecting passengers who have not gotten off a school bus using radar sensors according to an aspect of the present invention comprises a plurality of radar sensor modules installed at each row of seats inside a vehicle, installed in respective seat rows at heights corresponding to the seats on one side wall inside the school bus to detect a bio-signal of a person in a direction of the other side wall, wherein the system receives bio-signal detection results from the radar sensor modules to detect passengers who have not gotten off the vehicle. In this case, according to the present invention, control is performed so that passengers who have not gotten off the vehicle are detected in a time-division manner to prevent radar signals of the installed radar sensor modules from interfering with each other.

### CROSS-REFERENCE TO RELATED APPLICATION(S)

This application claims priority from Korean Patent Application No. 10-2024-0123258, filed on Sep. 10, 2024, in the Korean Intellectual Property Office, the disclosure of which is incorporated herein by reference in its entirety.

### BACKGROUND

### 1. Field

The present invention relates to a technology for managing the safety of a school bus, and more particularly, to a technology for detecting a bio-signal of a person inside a school bus using radar sensors.

### 2. Description of Related Art

Educational facilities such as schools operate school buses to transport children to school. However, safety accidents occur when it is not appropriately checked whether all children on board the school bus have gotten off or when the school bus departs without checking for children approaching the school bus or especially going under the school bus.

Korean pr No. 10-1388689 discloses a technology for preventing safety accidents by installing a radio frequency (RF) receiving terminal in a school bus and providing an RF transmitting terminal to children using the school bus so that a driver can know whether the children are on or off the bus and whether the RF transmitting terminals leave a set area when the children get off. Such conventional technology may cause a problem in that the technology cannot detect a child approaching the school bus when the child does not bring the RF transmitting terminal or the RF transmitting terminal is temporarily separated from the child (for example, the RF transmitting terminal is attached to a bag but the bag is put down separately).

### SUMMARY

The present invention is directed to providing a system for detecting passengers who have not gotten off a school bus, which is capable of detecting bio-signals of children who have not gotten off the school bus and remain inside the school bus using radar and generating an alarm.

A system for detecting passengers who have not gotten off a school bus using radar sensors according to an aspect of the present invention includes a plurality of side radar sensor modules, a plurality of upper radar sensor modules, an alarm indicator, and a power supply device.

The side radar sensor modules are installed in respective rows of seats at heights corresponding to the seats on one side wall inside the school bus to detect a bio-signal of a person under the seats toward the other side wall, the bio-signal being detected with an object detection area divided into sectors for respective positions of the seats.

The upper radar sensor modules are installed on upper parts of the one side wall inside the school bus to detect a bio-signal of a person over the seats.

The alarm indicator receives bio-signal detection results from the radar sensor modules to determine whether an alarm has occurred inside the school bus, and outputs a warning sound through a speaker and flashes one or more light emitting diodes (LEDs) when the alarm indicator determines that the alarm has occurred.

The power supply device receives power from the school bus to wake up from a sleep mode when an engine of the school bus is turned on, performs control so that the power from the school bus is supplied to the alarm indicator, performs control so that the power from the school bus is supplied to the radar sensor modules when the engine of the school bus is turned off, performs control so that the power supplied to the radar sensor modules and the alarm indicator from the school bus is cut off after a first time has elapsed, and then switches to the sleep mode and waits.

In this case, the power supply device sends a control message for starting bio-signal detection inside the school bus to the alarm indicator when the engine of the school bus is turned off, and the alarm indicator sends the bio-signal detection start control message in a time-division manner so that the side radar sensor module and the upper radar sensor module installed inside the school bus detect bio-signals at different times from other adjacent radar sensor modules.

According to an aspect of the present invention, the alarm indicator may send the bio-signal detection start control message to the radar sensor modules in a time-division manner, the bio-signal detection start control message being sent repeatedly in a set first cycle.

According to an aspect of the present invention, the alarm indicator may send the bio-signal detection start control message to the radar sensor modules in a time-division manner after waiting for a second time.

According to an aspect of the present invention, the plurality of side radar sensor modules, the plurality of upper radar sensor modules, the power supply device, and the alarm indicator of the system for detecting passengers who have not gotten off a school bus using radar sensors may be connected through a vehicle network, and the plurality of side radar sensor modules and the plurality of upper radar sensor modules may be connected in a daisy chain form.

According to an aspect of the present invention, the alarm indicator may transmit a control message for resetting power of a specific radar sensor module through vehicle network communication, and the radar sensor module that receives the control message for resetting the power from the alarm indicator performs a power reset.

According to an additional aspect of the present invention, when at least one of the radar sensor modules detects the bio-signal inside the school bus, the alarm indicator notifies a control server of a detection result through a mobile data terminal (MDT) inside the school bus.

### BRIEF DESCRIPTION OF THE DRAWINGS

FIG. 1 is a block diagram of a system for detecting passengers who have not gotten off a school bus using radar sensors according to an embodiment of the present invention.

FIG. 2 illustrates an example in which radar sensor modules are installed in a school bus according to an embodiment of the present invention.

FIGS. 3A and 3B illustrate examples in which the radar sensor modules installed inside the school bus are operated in a time-division manner to avoid radio interference.

FIG. 4 conceptually illustrates an example in which components of the present invention are connected via a vehicle network.

### DETAILED DESCRIPTION

The above-described and additional aspects are embodied through embodiments that will be described with reference to the accompanying drawings. It will be understood that various combinations of components of each embodiment are possible within the embodiment as long as there are no other statements or contradiction. Each block of a block diagram may represent a physical component in some cases, but may also be a logical representation of some functions of one physical component or functions of a plurality of physical components in other cases. Sometimes, an entity of a block or a part thereof may be a set of program instructions. All or some of these blocks may be implemented by hardware, software, or a combination thereof.

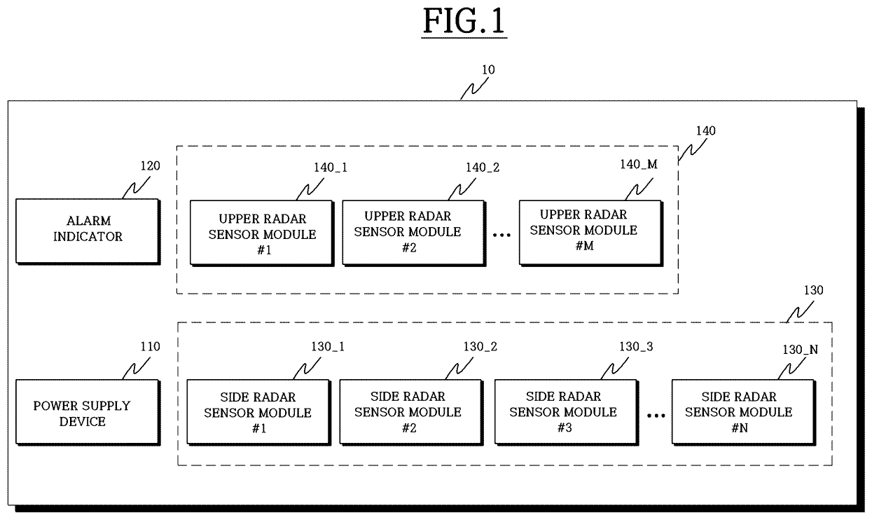

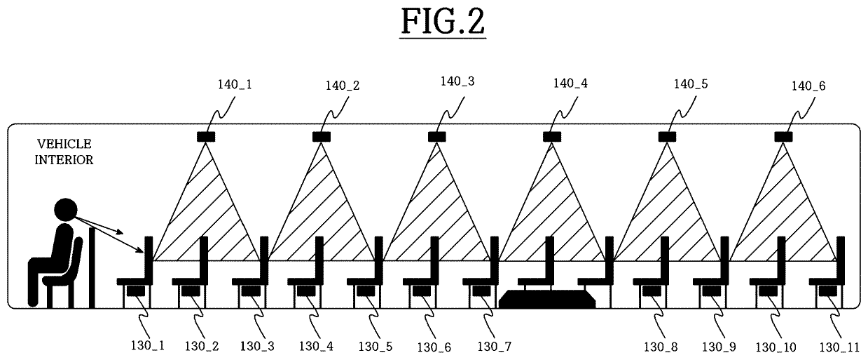

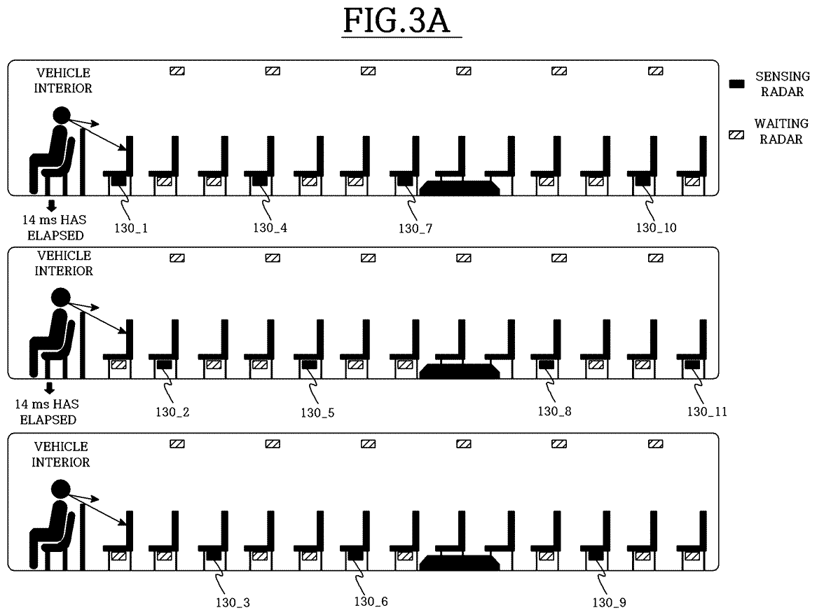

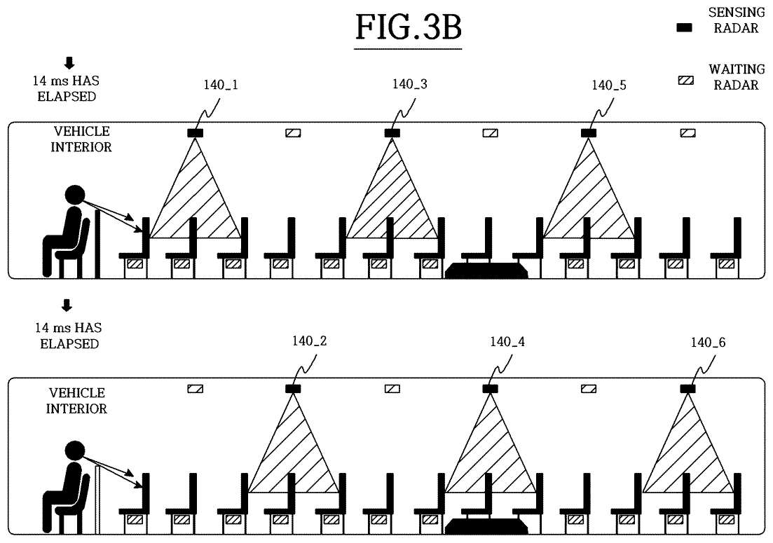

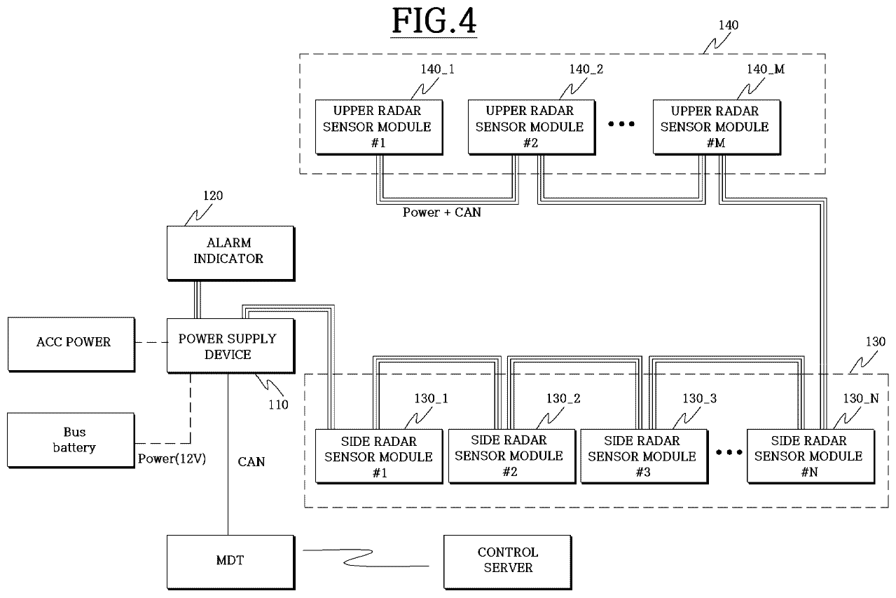

FIG. 1 is a block diagram of a system for detecting passengers who have not gotten off a school bus using radar sensors according to an embodiment of the present invention, FIG. 2 illustrates an example in which radar sensor modules are installed in a school bus according to an embodiment of the present invention, FIGS. 3A and 3B illustrate examples in which the radar sensor modules installed inside the school bus are operated in a time-division manner to avoid radio interference, and FIG. 4 conceptually illustrates an example in which components of the present invention are connected via a vehicle network.

A system 10 for detecting passengers who have not gotten off a school bus using radar sensors according to an aspect of the present invention includes a plurality of side radar sensor modules 130, a plurality of upper radar sensor modules 140, an alarm indicator 120, and a power supply device 110.

Respective components illustrated in FIG. 1 are connected via the vehicle network. For example, the respective components illustrated in FIG. 1 may be connected via a controller area network (CAN). However, the present invention is not limited thereto, and the components illustrated in FIG. 1 may be connected in other ways, and may be connected via a local interconnect network (LIN), FlexRay, Ethernet, or the like.

The system 10 for detecting passengers who have not gotten off a school bus of the present invention is preferably applied to relatively large vehicles such as school buses. It will be obvious that the present invention is not limited thereto, and the system 10 for detecting passengers who have not gotten off a school bus of the present invention may be applied to passenger vehicles.

The school bus generally includes seats arranged in an m×n form. For example, the school bus may include seats arranged so that 52 people (53 people when a last row has 5 seats) can board, with 2 seats on each side of a center aisle (m is 4) and a total of 13 rows (n is 13). In this case, in the present invention, since the side radar sensor module 130 is installed in each row, a total of 13 side radar sensor modules 130 may be installed. That is, the side radar sensor module 130 is installed in each row in which the seats are disposed in the vehicle, and has a detection area that is a lower part of the seats in each row. However, as illustrated in FIG. 2, there are 13 rows of seats in the vehicle, but when there are seats under which a child cannot go due to a protruding rear wheel, the side radar sensor module 130 may not be installed in the row of such seats.

A radar included in the side radar sensor module 130 is an ultra-short range radar (USSR) or a short range radar (SSR). There is no limitation on a radar operation scheme for the side radar sensor module 130, and a pulse Doppler scheme, a frequency modulated continuous wave (FMCW) scheme, a frequency shift keying (FSK) scheme, a UWB scheme, or the like may be used.

The side radar sensor module 130 is installed in each row of seats at a height corresponding to the seats to be directed from one side wall to the other side wall inside the school bus, and detects a bio-signal of a person under the seats toward the other side wall.

The side radar sensor module 130 is installed below the seat s near a height at which the seats are installed and has a detection area in which a child who has gone under the seats can be detected.

Further, the radar of the side radar sensor module 130 may generally be a radar having a field of view (FOV) so that all rows of installed seats can be included in a monitoring area, but is not limited thereto. That is, a detection area of the side radar sensor module 130 installed in a specific seat row may partially overlap a detection area of the side radar sensor module 130 installed in an adjacent seat row.

When each side radar sensor module 130 detects that an object whose bio-signal is detected inside the vehicle, that is, a child, is on board, the side radar sensor module 130 reports an object detection result through the vehicle network to which the side radar sensor module 130 is connected. In this case, each side radar sensor module 130 may attempt to detect the bio-signal for a set time (for example, 30 seconds).

According to an aspect of the invention, the side radar sensor module 130 may detect the bio-signal, with an object detection area from the one side wall to the other side wall divided into sectors for each seat position.

The side radar sensor module 130 may be installed to be directed toward the other side wall from the one side wall inside the school bus, to detect a bio-signal in each sector, with an area corresponding to a position of each seat in each row divided into sectors. The side radar sensor module 130 detects the bio-signal, with the inside of the school bus divided into sectors corresponding to the number of seats in a width direction. For example, when there are four seats in one row, the side radar sensor module 130 may detect the bio-signal in each of four divided sectors.

The side radar sensor module 130 may be implemented as a radar, and a signal processing circuit or a computing device including the signal processing circuit connected to an output terminal of the radar.

The side radar sensor module 130 includes a radar circuit, and a radar signal processing unit including a digital signal processor (DSP), which is an application processor, and the radar signal processing unit processes radar signals output through the plurality of transmitting antennas, reflected by a target, and received by the plurality of receiving antennas to output data including a Doppler value, distance data, and point cloud data.

The radar signal processing unit sequentially transmits a radar waveform signal to an internal space of the vehicle through the plurality of transmitting antennas, and processes and outputs signals received through the plurality of receiving antennas.

The transmitting antennas and the receiving antennas may be patch array antennas.

The radar generates the radar waveform signal through a variable frequency oscillator according to a modulation and demodulation control signal. For example, the radar generates and outputs an FMCW radar waveform signal whose frequency increases linearly and then decreases during a period called a chirp according to the modulation and demodulation control signal through the variable frequency oscillator. The radar transmits the radar waveform signal to the internal space of the vehicle through the transmitting antenna.

The radar waveform signal transmitted through the transmitting antenna is reflected by the target and received by the receiving antenna.

The radar of the side radar sensor module 130 performs low noise amplification on the radar waveform signal received through the receiving antenna, performs demodulation to convert the signal into a baseband signal, and performs analog-to-digital conversion for conversion into a digital signal.

The radar signal processing unit processes the converted digital signal through a DSP to output distance data (range) and a Doppler value. The DSP compares the transmitted FMCW radar waveform signal with the received FMCW radar waveform signal to measure a delay value and a Doppler shift, thereby measuring data of a distance to the target and the Doppler value.

Further, the radar signal processing unit converts the distance data and the Doppler value acquired by processing the digital signal into absolute coordinates (Cartesian conversion), and performs angle correction according to a speed and correction according to an installation position of a radar device to finally generate point cloud data. The point cloud data generated by the radar signal processing unit is a four-dimensional point cloud including three-dimensional coordinates and the Doppler value.

The side radar sensor module 130 further includes a bio-signal detection unit, which detects a bio-signal of a person for each sector, with the detection area divided into sectors corresponding to the number of seats in a width direction, from output data of the radar signal processing unit.

When power corresponding to a bio-signal frequency is detected in each sector, the bio-signal detection unit determines that a micro-movement or minute motion caused by a respiration or pulse, that is, a bio-signal, is detected. In this case, the bio-signal detection unit may need to perform signal processing on signals for a certain time, including previous signals, in order to detect regular signals such as respiration or pulse. The bio-signal detection unit performs signal processing only on a signal reflected at a position corresponding to a specific sector, and may perform signal processing for bio-signal detection sequentially for each sector or perform signal processing for bio-signal detection in parallel for all sectors or a plurality of sectors simultaneously.

According to the aspect of the invention, the bio-signal detection unit may perform digital beamforming with respect to a position of each sector and then process the signal to detect a bio-signal caused by a person breathing or the like.

When a child goes under a seat inside the vehicle, the driver cannot check this through a rearview mirror, and thus the side radar sensor module 130 may report a detection result each time a bio-signal is detected in the detection area.

Power may be supplied to the side radar sensor module 130 through some strands of a cable (for example, a UTP cable) used for vehicle network connection.

The plurality of upper radar sensor modules 140 are installed in upper parts of the one side wall inside the school bus to detect bio-signals of persons over the seats.

Each upper radar sensor module 140 detects a bio-signal of a child sitting or lying on the seat, with two rows of seats disposed in the school bus set as a detection area in the upper part of the one side wall inside the vehicle. In this case, since a first row of seats can be visually checked by the driver, the first row of seats may be excluded from the detection area. For example, when 13 rows of seats are installed on both sides of the center aisle, six upper radar sensor modules 140 may be installed for the rows of seats other than the first row of seats. However, the present invention is not limited thereto, and one upper radar sensor module 140 may have a detection area including one row of seats or a detection area including three or more rows of seats in consideration of, for example, a height at which the upper radar sensor module 140 is installed depending on shapes of the seats.

Further, the detection area of the radar of one upper radar sensor module 140 may partially overlap the detection area of the radar of another adjacent upper radar sensor module 140. In this case, each upper radar sensor module 140 may report that the bio-signal has been detected.

It is preferable for the upper radar sensor module 140 to include the same radar sensor module as the side radar sensor module 130. However, the radars of the upper radar sensor module 140 and the side radar sensor module 130 may have different radar parameters set as necessary depending on the purposes of the radar sensor modules. Therefore, the radar of the upper radar sensor module 140 is also a USSR or an SSR. There is no limitation on a radar operation scheme for the upper radar sensor module 140, and a pulse Doppler scheme, an FMCW scheme, an FSK scheme, a UWB scheme, or the like may be used.

When each upper radar sensor module 140 detects that an object whose bio-signal is detected inside the vehicle, that is, a child is on board, the upper radar sensor module 140 reports an object detection result through the vehicle network to which the upper radar sensor module 140 is connected. In this case, each upper radar sensor module 140 may attempt to detect the bio-signal for a set time (for example, 30 seconds).

The upper radar sensor module 140 may also be implemented as a radar, and a signal processing circuit or a computing device including the signal processing circuit connected to an output terminal of the radar, similar to the side radar sensor module 130. Detailed description of each configuration is as described above.

Power may be supplied to the upper radar sensor module 140 through some strands of a cable (for example, a UTP cable) used for vehicle network connection.

The alarm indicator 120 includes a speaker that outputs an alarm sound or the like, and one or more LEDs that indicate the occurrence of an alarm. For example, the alarm indicator 120 includes a green LED and a red LED, and turns on or flashes the red LED when a bio-signal of a child is detected inside the vehicle, and turns on or flashes the green LED when no bio-signal of a child is detected inside the vehicle.

The alarm indicator 120 receives a bio-signal detection result from the side radar sensor module 130 and the upper radar sensor module 140 through the vehicle network. The side radar sensor module 130 and the upper radar sensor module 140 perform bio-signal detection for the detection area for a set time, and then report a bio-signal detection result to the alarm indicator 120 regardless of whether a bio-signal is detected or report the bio-signal detection result to the alarm indicator 120 only when a bio-signal is detected, and the alarm indicator 120 determines whether an alarm occurs inside the school bus based on the received object detection result.

When the alarm indicator 120 determines that the bio-signal is detected inside the vehicle based on a determination result of the bio-signal detection result, the alarm indicator 120 outputs a warning sound through the speaker and turns on or flashes one or more LEDs to indicate a warning. When the alarm indicator 120 determines that no bio-signals are detected inside the vehicle, the alarm indicator 120 may turn on or flash one or more LEDs to indicate normality and output a predetermined sound through the speaker.

The power supply device 110 converts ACC power and/or battery power of the vehicle to 24 V and provides 24 V to the radar sensor modules 130 and 140 installed inside the vehicle and the alarm indicator 120 when the radar sensor modules 130 and 140 installed inside the vehicle and the alarm indicator 120 require the power. The power supply device 110 is operated in an operating mode and a sleep mode, and when the school bus is started, the power supply device 110 is booted and operated in the operating mode. The power supply device 110 supplies the vehicle battery power to the radar sensor modules 130 and 140.

When an engine of the school bus is turned on, the power supply device 110 receives power (school bus battery power) from the school bus and wakes up from the sleep mode. When the power supply device 110 wakes up from the sleep mode, the power supply device 110 performs control so that the battery power of the school bus is supplied to the alarm indicator 120. In this case, the power supply device 110 may also perform control so that the power from the school bus is supplied to the radar sensor modules 130 and 140, check that the radar sensor modules 130 and 140 are booted up normally with the power supplied from the school bus, and then cut off the supply of the power so that the radar sensor modules 130 and 140 and not transmit the radar signal while the school bus is in operation, that is, while passengers are on board. When the school bus has completed its operation and the driver turns off the engine of the school bus, the power supply device 110 performs control so that the power from the school bus is supplied to the radar sensor modules 130 and 140, performs control so that the supply of the power to the radar sensor modules 130 and 140 and the alarm indicator 120 from the school bus is cut off after a first time (for example, 3 minutes), and then switches to the sleep mode and waits.

Further, when the engine of the school bus is turned off, the power supply device 110 sends a control message for starting bio-signal detection inside the school bus to the alarm indicator 120. That is, when the engine is turned off to allow children to get off after the school bus stops, the power supply device 110 detects this and sends a bio-signal detection start control message to the alarm indicator 120 so that any children who have not gotten off the vehicle and remain inside the vehicle are detected.

The alarm indicator 120 sends the bio-signal detection start control message to the side radar sensor module 130 and the upper radar sensor module 140 installed inside the school bus so that the side radar sensor module 130 and the upper radar sensor module 140 detect bio-signals of passengers who have not gotten off the vehicle inside the vehicle. Since there are a plurality of side radar sensor modules 130 and upper radar sensor modules 140 installed inside the school bus, interference with radar signals transmitted by other adjacent radar sensor modules 130 and 140 may occur, resulting in an error in bio-signal detection. Accordingly, the alarm indicator 120 may send the bio-signal detection start control message in a time-division manner so that the side radar sensor module 130 and the upper radar sensor module 140 installed in the school bus detect bio-signals at different times from the other adjacent radar sensor modules. There is no limitation on a time-division scheme in which the alarm indicator 120 sends the bio-signal detection start control message. For example, the alarm indicator 120 may sequentially send the bio-signal detection start control message so that the respective radar sensor modules detect bio-signals at different times, or may sequentially send the bio-signal detection start control message so that bio-signals are detected at different times by groups of radar sensor modules, which are installed at regular intervals and grouped.

The examples illustrated in FIGS. 3A and 3B are examples in which the bio-signal detection start control message is sequentially sent so that bio-signals are detected at different times for each group. In the example of FIGS. 3A and 3B, the alarm indicator 120 sends the bio-signal detection start control message to a first group consisting of side radar sensor modules 130_1, 130_4, 130_7, and 130_10 so that the radar sensor modules in the first group detect passengers who have not gotten off the vehicle, waits for a predetermined time (14 ms), sends the bio-signal detection start control message to a second group consisting of side radar sensor modules 130_2, 130_5, 130_8, and 130_11 so that the radar sensor modules in the second group detect passengers who have not gotten off the vehicle, waits for another predetermined time (14 ms), sends the bio-signal detection start control message to a third group consisting of the side radar sensor modules 130_3, 130_6, and 130_9 so that the radar sensor modules in the third group detect passengers who have not gotten off the vehicle, waits for another predetermined time (14 ms), sends the bio-signal detection start control message to a fourth group consisting of upper radar sensor modules 140_1, 140_3, and 140_5 so that the radar sensor modules in the fourth group detect passengers who have not gotten off the vehicle, waits for a certain time (14 ms), and sends the bio-signal detection start control message to a fifth group consisting of upper radar sensor modules 140_2, 140_4, and 140_6 so that the radar sensor modules in the fifth group detect passengers who have not gotten off the vehicle.

The radar sensor module 130 or 140 that receives the bio-signal detection start control message from the alarm indicator 120 detects a bio-signal of a passenger who has not gotten off the vehicle inside the school bus in a set first cycle.

In this case, the alarm indicator 120 sends a bio-signal detection start control message to the radar sensor module 130 or 140 in time division after waiting for the second time in consideration of, for example, a time when children get off after the school bus stops and a time when the driver gets off.

The radar sensor module 130 or 140 that receives the bio-signal detection starts control message attempts to detect the bio-signal of a passenger who has not gotten off for a set time (for example, 30 seconds).

As illustrated in FIG. 3A and FIG. 3B, the plurality of side radar sensor modules 130, the plurality of upper radar sensor modules 140, the power supply device 110, and the alarm indicator 120 are connected through a vehicle network. In this case, the plurality of side radar sensor modules 130 and the plurality of upper radar sensor modules 140 are communicatively connected in a daisy chain form through the vehicle network.

Additionally, the alarm indicator 120 may transmit a control message for resetting power of a specific radar sensor module through the vehicle network communication. The alarm indicator transmits a power reset control message to a specific radar sensor module that generates a false alarm, that is, malfunctions, such as detecting presence of a bio-signal even though a child is not on board, in order to reset the specific radar sensor module.

In this case, the radar sensor module that receives the power reset control message from the alarm indicator 120 may perform a power reset.

### Item 6

According to an additional aspect of the present invention, when at least one of the radar senor modules detects a bio-signal inside the school bus, the alarm indicator 120 notifies a control server of a detection result through a mobile data terminal (MDT) inside the school bus. The control server notifies a person in charge of a school or relevant authority that the bio-signal is detected inside the school bus, that is, that a child is not getting off and is remaining, so that the person in charge can take action.

According to the present invention, it is possible to provide a system that is capable of detecting a bio-signal of a child who has not gotten off a school bus and remains inside the school bus using radar and generating an alarm.

Various embodiments disclosed in the present specification and drawings are only specific examples presented to help understanding, and are not intended to limit the scope of such embodiments of the present invention.

Therefore, the scope of the embodiments of the present invention should be construed as including all changes or modifications derived based on the technical spirit of the embodiments of the present invention, in addition to the embodiments described herein.

What is claimed is:

1. A system for detecting passengers who have not gotten off a school bus using radar sensors, the system comprising:
a plurality of side radar sensor modules installed in respective rows of seats at heights corresponding to the seats on one side wall inside the school bus to detect a bio-signal of a person under the seats toward the other side wall, the bio-signal being detected with an object detection area divided into sectors for respective positions of the seats;
a plurality of upper radar sensor modules installed on upper parts of the one side wall inside the school bus to detect a bio-signal of a person over the seats;
an alarm indicator configured to receive bio-signal detection results from the radar sensor modules to determine whether an alarm has occurred inside the school bus, and output a warning sound through a speaker and flash one or more light emitting diodes (LEDs) when the alarm indicator determines that the alarm has occurred; and
a power supply device configured to receive power from the school bus to wake up from a sleep mode when an engine of the school bus is turned on, perform control so that the power from the school bus is supplied to the alarm indicator, perform control so that the power from the school bus is supplied to the radar sensor modules when the engine of the school bus is turned off, perform control so that the power supplied to the radar sensor modules and the alarm indicator from the school bus is cut off after a first time has elapsed, and then switch to the sleep mode and wait,
wherein the power supply device sends a control message for starting bio-signal detection inside the school bus to the alarm indicator when the engine of the school bus is turned off, and the alarm indicator sends the bio-signal detection start control message in a time-division manner so that the side radar sensor module and the upper radar sensor module installed inside the school bus detect bio-signals at different times from other adjacent radar sensor modules.

2. The system for detecting passengers who have not gotten off a school bus using radar sensors of claim 1, wherein the radar sensor module that receives the bio-signal detection start control message from the alarm indicator detects the bio-signal in a set first cycle.

3. The system for detecting passengers who have not gotten off a school bus using radar sensors of claim 1, wherein the alarm indicator sends the bio-signal detection start control message to the radar sensor modules in a time-division manner after waiting for a second time.

4. The system for detecting passengers who have not gotten off a school bus using radar sensors of claim 1, wherein:
the plurality of side radar sensor modules, the plurality of upper radar sensor modules, the power supply device, and the alarm indicator are connected through a vehicle network, and
the plurality of side radar sensor modules and the plurality of upper radar sensor modules are connected in a daisy chain form.

5. The system for detecting passengers who have not gotten off a school bus using radar sensors of claim 4, wherein:
wherein the alarm indicator transmits a control message for resetting power of a specific radar sensor module through vehicle network communication, and
the radar sensor module that receives the control message for resetting the power from the alarm indicator performs a power reset.

6. The system for detecting passengers who have not gotten off a school bus using radar sensors of claim 1, wherein, when at least one of the radar sensor modules detects the bio-signal inside the school bus, the alarm indicator notifies a control server of a detection result through a mobile data terminal (MDT) inside the school bus.
